(19) United States
(12) Patent Application Publication
(10) Pub. No.: US 2026/0264393 A1
(43) Pub. Date: Sep. 10, 2026

(54) LIQUID EJECTION HEAD

(71) Applicant: RISO Technologies Corporation, Tokyo (JP)

(72) Inventor: Masato FUKASAWA, Mishima Shizuoka (JP)

(21) Appl. No.: 19/417,296

(22) Filed: Dec. 11, 2025

(30) Foreign Application Priority Data
Mar. 5, 2025 (JP) 2025-034999

(51) Int. Cl. B41J 2/045; B41J 2/14; B41J 29/13; B41J 29/377

(52) U.S. Cl. CPC B41J 2/04515; B41J 2/04581; B41J 2/14201; B41J 29/13; B41J 29/377; B41J 2002/14419

(57) ABSTRACT

A liquid ejection head includes a nozzle, a pressure chamber that communicates with the nozzle and stores a first liquid, an actuator configured to change a volume of the pressure chamber, a manifold unit that forms a first flow path running along the actuator and through which a temperature control liquid flows, a driving IC configured to drive the actuator, and a temperature adjustment structure that includes: a temperature control manifold that forms a second flow path running along the driving IC and through which the temperature control liquid flows, and a pair of temperature control blocks, one of which forms a branching flow path and the other of which forms a merging flow path. A heat conductivity of the pair of temperature control blocks is lower than a heat conductivity of the temperature control manifold.

### CROSS-REFERENCE TO RELATED APPLICATION

This application is based upon and claims the benefit of priority from Japanese Patent Application No. 2025-034999, filed on March 5, 2025, the entire contents of which are incorporated herein by reference.

### FIELD

Embodiments described herein relate generally to a liquid ejection head.

### BACKGROUND

In a liquid ejection head that ejects a liquid such as ink, a known technique is to perform stable printing by controlling the ink temperature of an actuator. Since heating elements, such as a driving IC that drives the actuator, generate heat during printing, the liquid ejection head requires a mechanism that adjusts the temperature of the actuator and prevents a temperature rise of the heating elements, such as the driving IC.

Therefore, a liquid ejection head is known that uses a temperature adjustment flow path to perform temperature adjustments, such as controlling the temperature of the ink and cooling the heating elements. However, if the same temperature control flow path is branched and used to both control the temperature of the ink and cool the heating elements, heat generated by the heating elements may transfer to the actuator from the members that constitute the temperature adjustment flow path or the temperature adjustment water, which can make controlling the temperature of the actuator difficult.

### BRIEF DESCRIPTION OF THE DRAWINGS

FIG. 1 is a perspective view illustrating a liquid ejection head according to an embodiment.

FIG. 2 is an exploded perspective view illustrating the liquid ejection head.

FIG. 3 is a side view illustrating the liquid ejection head.

FIG. 4 is a cross-sectional view illustrating the liquid ejection head.

FIG. 5 is a diagram illustrating the liquid ejection head as viewed from a nozzle plate side.

FIG. 6 is a perspective view illustrating a head body and a manifold unit of the liquid ejection head.

FIG. 7 is a cross-sectional view illustrating the head body and the manifold unit.

FIG. 8 is a cross-sectional view illustrating the head body and the manifold unit.

FIG. 9 is a diagram partially illustrating the head body.

FIG. 10 is an exploded perspective view illustrating a temperature adjustment flow path unit according to an embodiment.

FIG. 11 is an enlarged perspective view illustrating the liquid ejection head.

### DETAILED DESCRIPTION

Embodiments of the present disclosure provide a liquid ejection head capable of preventing heat generated by a heating element from being conducted to an actuator.

In general, according to one embodiment, a liquid ejection head comprises a nozzle plate including a nozzle through which a first liquid is ejected; a pressure chamber that communicates with the nozzle and stores the first liquid; an actuator configured to change a volume of the pressure chamber to eject the first liquid; a manifold unit that forms a first flow path running along the actuator and through which a temperature control liquid flows; a driving IC configured to drive the actuator; and a temperature adjustment structure that includes: a temperature control manifold that forms a second flow path running along the driving IC and through which the temperature control liquid flows, and a pair of temperature control blocks, one of the blocks forming a branching flow path through which the temperature control liquid flows into the first and second flow paths, and the other of the blocks forming a merging flow path by which the temperature control liquid from the first and second flow paths merges. A heat conductivity of the pair of temperature control blocks is lower than a heat conductivity of the temperature control manifold.

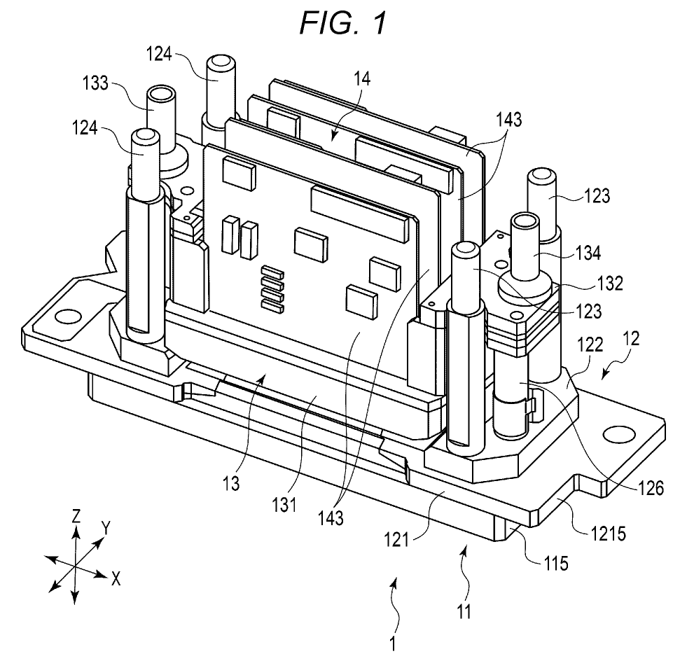

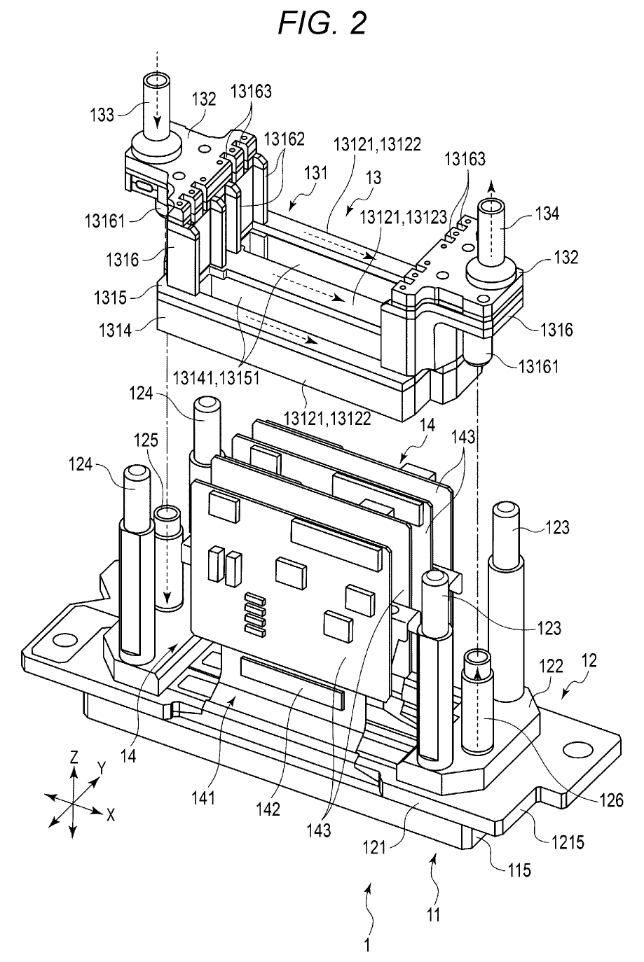

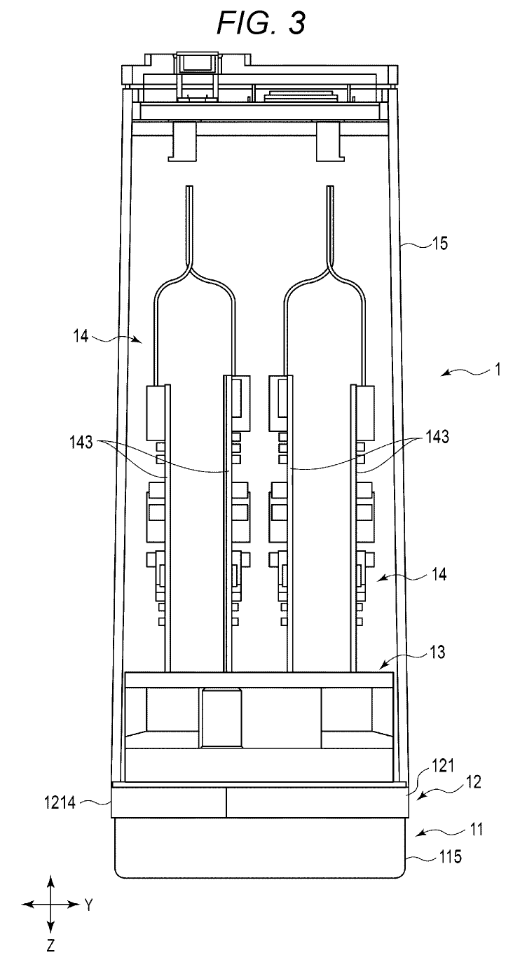

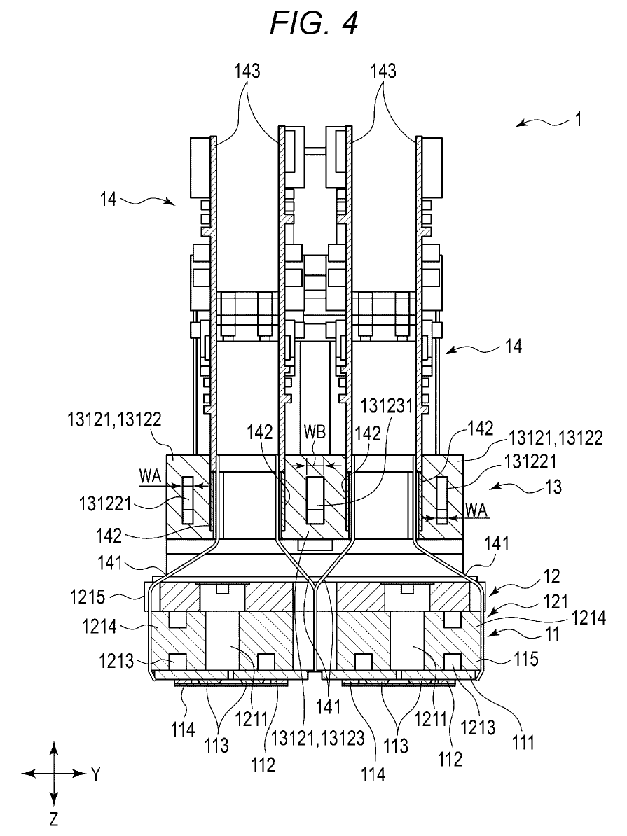

A liquid ejection head 1 according to an embodiment will be described below with reference to FIGS. 1 to 11. FIG. 1 is a perspective view illustrating the liquid ejection head 1 according to an embodiment, with a cover 15 omitted. FIG. 2 is an exploded perspective view illustrating the liquid ejection head 1, with the cover 15 omitted, FIG. 3 is a side view illustrating the liquid ejection head 1, and FIG. 4 is a cross-sectional view illustrating the liquid ejection head 1, with the cover 15 omitted.

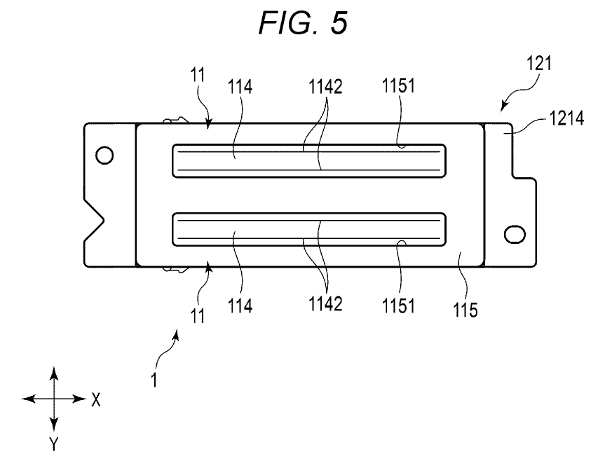

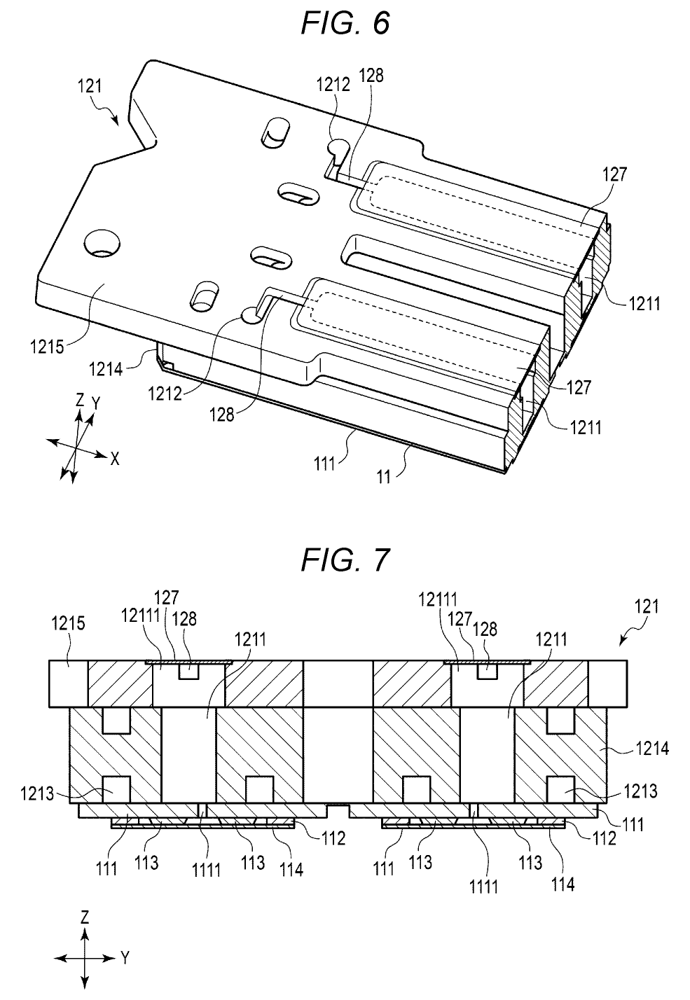

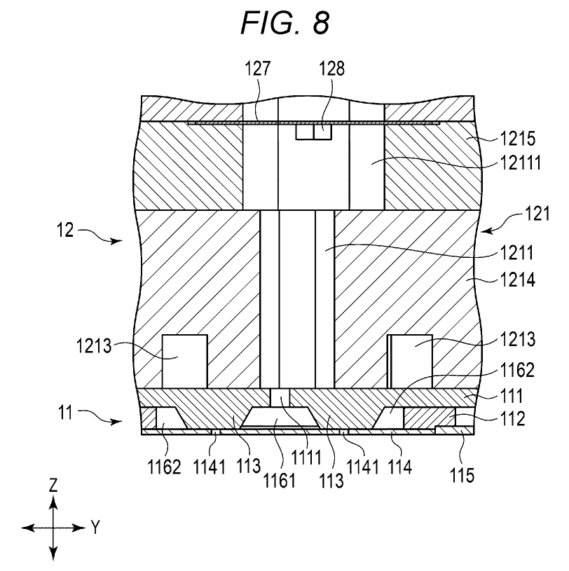

FIG. 5 is a diagram illustrating the liquid ejection head 1 from a nozzle plate 114 side. FIG. 6 is a perspective view illustrating a head body 11 and manifold unit 12 of the liquid ejection head 1 by a partial cross section, FIG. 7 is a cross-sectional view illustrating the head body 11 and the manifold unit 12, and FIG. 8 is an enlarged cross-sectional view illustrating the head body 11 and the manifold unit 12.

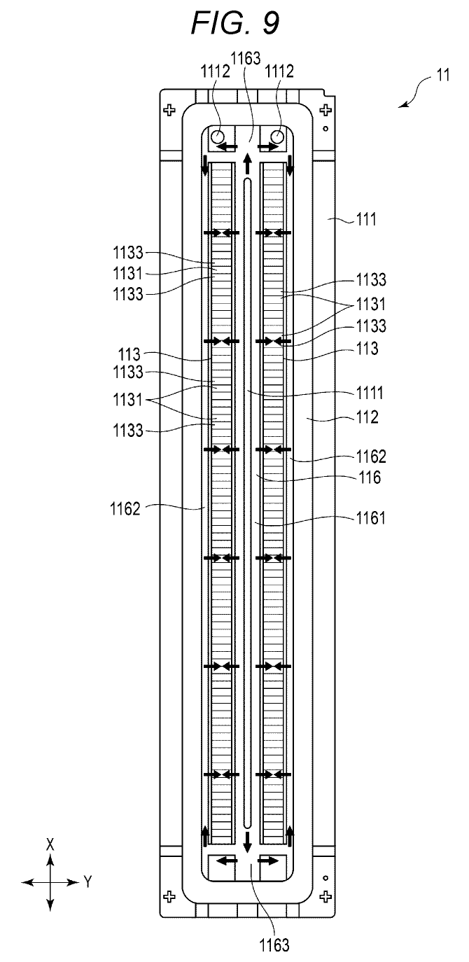

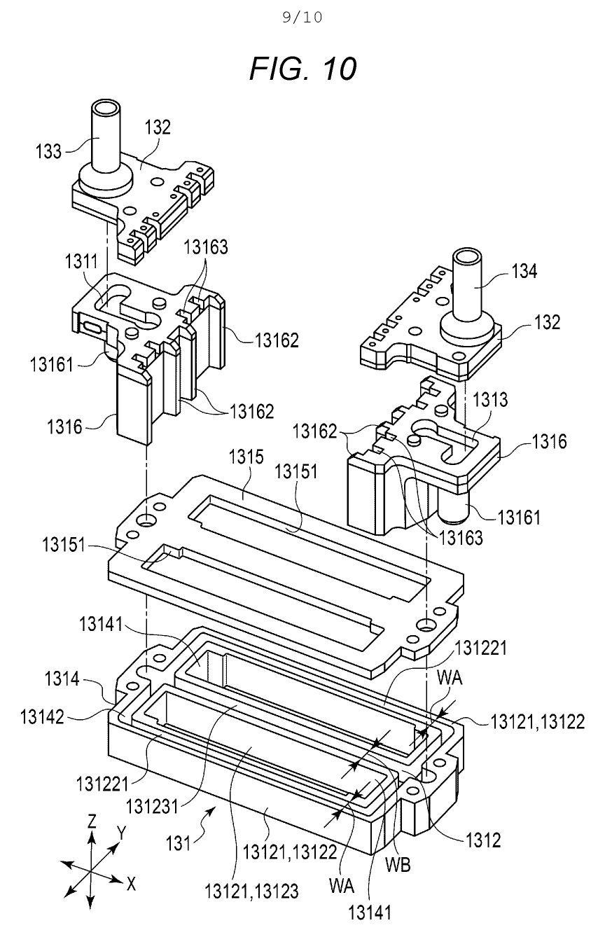

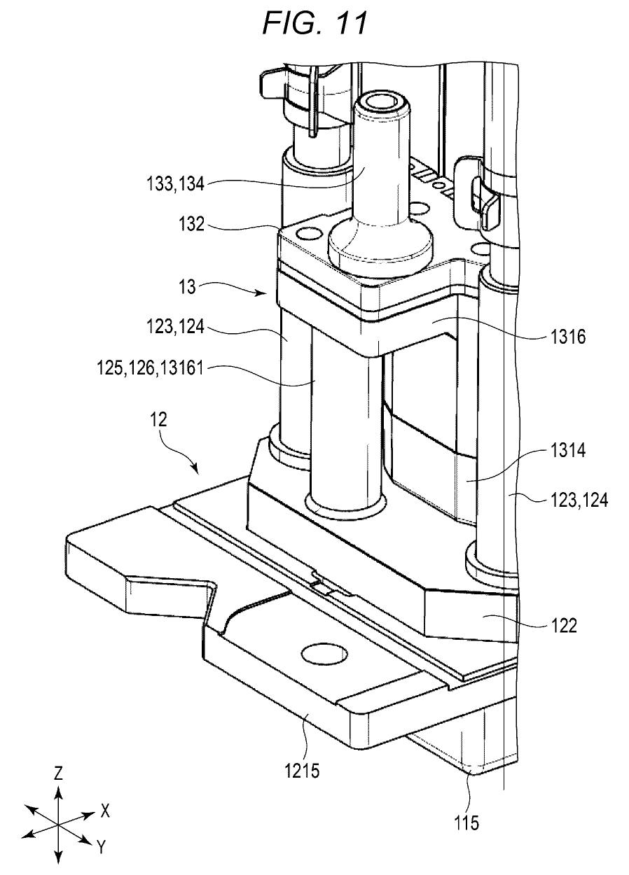

FIG. 9 is a diagram illustrating the head body 11 with some parts omitted. FIG. 10 is an exploded perspective view illustrating a temperature adjustment flow path unit 13 (hereinafter also referred to as a temperature adjustment structure). FIG. 11 is an enlarged perspective view illustrating the manifold unit 12 and the temperature adjustment flow path unit 13 of the liquid ejection head 1. In FIG. 2, an example of temperature control water flow is indicated by dashed arrows.

The X axis, Y axis, and Z axis illustrated in FIGS. 1 to 11 are orthogonal to each other. In the following description, a direction along the X axis is referred to as a direction X, a direction along the Y axis is referred to as a direction Y, and a direction along the Z axis is referred to as a direction Z. In the drawings, each element is illustrated enlarged, reduced, or omitted as appropriate for the purpose of description.

The liquid ejection head 1 is, for example, an inkjet head provided in a liquid ejection device such as an inkjet recording device or an inkjet printer. The liquid ejection head 1 is provided in a head unit including a supply tank serving as a liquid container provided in the liquid ejection device.

The liquid ejection head 1 is supplied with ink as a liquid stored in the supply tank. The liquid ejection head 1 may be a non-circulation type head that does not circulate the ink, or may be a circulation type head that circulates the ink. In the present embodiment, the liquid ejection head 1 will be described using an example of a non-circulation type head. The liquid ejection head 1 is also connected to a temperature control device provided in the liquid ejection device, and is supplied with a temperature control liquid (temperature control water) that controls temperatures of a heating element and an actuator. The liquid ejection head 1, together with the temperature control device, constitutes a circulation structure of the temperature control water.

As illustrated in FIGS. 1 to 4, the liquid ejection head 1 includes the head body 11, the manifold unit 12, the temperature adjustment flow path unit 13, a circuit board 14, and the cover 15. For example, the liquid ejection head 1 is a side shooter type four-row integral structure head including two sets of the head bodies 11 each including a pair of actuators 113.

The head body 11 ejects a liquid. As illustrated in FIGS. 3 to 9, the head body 11 includes a base plate 111, a frame 112, the actuators 113, the nozzle plates 114, and a mask plate 115. The head body 11 also has a common liquid chamber 116. In the present embodiment, one head body 11 includes two actuators 113.

As illustrated in FIGS. 7 to 9, the base plate 111 is formed into a rectangular plate shape from, for example, a ceramic material. The base plate 111 is formed, for example, in a rectangular shape that is long in one direction (direction X). As illustrated in FIG. 9, the base plate 111 has a single supply port 1111 and one or a plurality of discharge ports 1112. The base plate 111 is provided with the pair of actuators 113, and is formed with a wiring pattern for driving the actuators 113. The supply port 1111 and the discharge ports 1112 are through holes that penetrate between two surfaces of the base plate 111.

The supply port 1111 is provided singly at a position facing a first common liquid chamber 1161, which will be described below, of the common liquid chamber 116, for example. The supply port 1111 is, for example, an elongated hole that is long in one direction along a longitudinal direction (direction X) of the first common liquid chamber 1161. The supply port 1111 is, for example, a rectangular shape that is long in one direction, or an elongated hole with semicircular ends having a uniform width. A longitudinal width of the supply port 1111 is set, for example, to a length equal to or greater than a longitudinal width (length) of the actuator 113, or smaller than the length of the actuator 113, and to a length approximately the same as a range (total nozzle range) in which a pressure chamber 1131 formed in the actuator 113 that is driven during normal ink ejection is provided.

For example, two discharge ports 1112 are provided at positions facing at least one of two third common liquid chambers 1163, which will be described below, of the common liquid chamber 116. For example, as illustrated in FIG. 9, the discharge ports 1112 are provided in the base plate 111 in a manner of being adjacent to ends of the pair of actuators 113 on one side in a longitudinal direction thereof and arranged on one side of the third common liquid chambers 1163. It should be noted that two discharge ports 1112 may be provided in each of the two third common liquid chambers 1163 of the common liquid chamber 116, for example.

As illustrated in FIG. 9, the frame 112 is fixed to one surface of the base plate 111 with an adhesive or the like. The frame 112 surrounds the supply port 1111, the plurality of discharge ports 1112, and the actuators 113 provided on the base plate 111.

For example, the frame 112 is formed in a rectangular frame shape that is long in one direction (direction X), so as to form an opening that is long in one direction along a longitudinal direction of the frame 112. The pair of actuators 113, the supply port 1111 and the two discharge ports 1112 are arranged in the opening of the frame 112.

The actuator 113 is formed in a plate shape that is long in one direction (direction X). The pair of actuators 113 are adhered to a mounting surface of the base plate 111. As illustrated in FIG. 9, the pair of actuators 113 are provided on the base plate 111 in a manner of sandwiching the supply port 1111 and are arranged in two rows in a short direction (direction Y) perpendicular to the longitudinal direction of the actuators 113. The actuators 113 are arranged within the opening of the frame 112 and are adhered to the surface of the base plate 111. As an example, the actuator 113 is formed by adhering together two rectangular plate-shaped piezoelectric materials that are long in one direction in a manner of facing each other such that polarization directions thereof are opposite to each other. Here, the piezoelectric material is, for example, lead zirconate titanate (PZT). The actuator 113 is adhered to the mounting surface of the base plate 111 by, for example, a thermosetting epoxy adhesive.

The actuator 113 has, for example, a plurality of pressure chambers 1131 arranged at equal intervals in the longitudinal direction (direction X). The actuator 113 has a plurality of grooves formed in the longitudinal direction of the actuator 113 on a surface side opposite to the base plate 111 side, and these grooves form the pressure chambers 1131. In other words, the actuator 113 has a plurality of walls 1133 that are arranged at equal intervals in the longitudinal direction and form grooves therebetween. The plurality of walls 1133 form the plurality of pressure chambers 1131 between adjacent ones of the walls. That is, the plurality of walls 1133 are partition walls that separate the plurality of pressure chambers 1131. The wall 1133 is a piezoelectric element that serves as a driving element that changes a volume of the pressure chamber 1131 when a drive voltage is applied thereto.

A surface of the actuator 113 opposite to the base plate 111 is adhered to the nozzle plate 114. The actuator 113 is formed with a wiring pattern for driving the plurality of pressure chambers 1131.

Each of the pressure chambers 1131 ejects the ink from a nozzle hole 1141 when the liquid ejection head 1 performs an operation such as printing. It should be noted that in the present embodiment, the actuator 113 has a plurality of pressure chambers 1131, but for example, air chambers that do not eject the ink may be arranged alternately with the plurality of pressure chambers 1131.

As illustrated in FIGS. 4, 5, 7 and 8, the nozzle plate 114 is formed in a plate shape. The nozzle plate 114 is fixed to the surface of the frame 112 opposite to the base plate 111 with an adhesive or the like. The nozzle plate 114 has a plurality of nozzle holes 1141 formed at positions facing the plurality of pressure chambers 1131. In the present embodiment, the nozzle plate 114 has two nozzle rows 1142 in which the plurality of nozzle holes 1141 are aligned in one direction (direction X). In the present embodiment, the liquid ejection head 1 has two sets of head bodies 11, and therefore, as illustrated in FIG. 5, the liquid ejection head 1 has four nozzle rows 1142.

The plurality of nozzle holes 1141 facing the plurality of pressure chambers 1131 eject ink (droplets) when the liquid ejection head 1 performs an operation such as printing.

The mask plate 115 covers, for example, outer surfaces of the nozzle plates 114, outer peripheries of the nozzle plates 114, an outer periphery of the frame 112, and an outer periphery of the base plate 111. The mask plate 115 also covers a first manifold 1214, which will be described below, of the manifold unit 12.

As illustrated in FIG. 5, the mask plate 115 has a pair of windows 1151 that expose the nozzle rows 1142 each including the plurality of nozzle holes 1141 that eject the liquid of the pair of nozzle plates 114.

As illustrated in FIG. 9, the common liquid chamber 116 is communicated with the supply port 1111. The common liquid chamber 116 is provided around the pair of actuators 113. Specifically, the common liquid chamber 116 is communicated with a primary side and a secondary side of the plurality of pressure chambers 1131 of each actuator 113. The common liquid chamber 116 is also communicated with the discharge ports 1112.

For example, as illustrated in FIG. 9, the common liquid chamber 116 has the first common liquid chamber 1161 that is long in one direction (direction X), two second common liquid chambers 1162 that are long in one direction (direction X), and the third common liquid chambers 1163 that connect both ends of the first common liquid chamber 1161 to both ends of the two second common liquid chambers 1162. The common liquid chamber 116 allows the supply port 1111 to communicate with one opening of the plurality of pressure chambers 1131 of the actuator 113 via the first common liquid chamber 1161, and allows the third common liquid chambers 1163 to communicate with the other opening of the plurality of pressure chambers 1131 via the second common liquid chambers 1162.

The first common liquid chamber 1161 is formed between the pair of actuators 113. The first common liquid chamber 1161 forms an ink flow path from the supply port 1111 to one opening of the plurality of pressure chambers 1131 of each actuator 113. The first common liquid chamber 1161 also forms an ink flow path from the supply port 1111 to the two third common liquid chambers 1163 on both end sides in the longitudinal direction (direction X) of the first common liquid chamber 1161 (actuators 113).

The second common liquid chamber 1162 is formed between each actuator 113 and the frame 112. The second common liquid chamber 1162 forms an ink flow path from the third common liquid chamber 1163 to the other opening of the plurality of pressure chambers 1131.

The third common liquid chambers 1163 are adjacent to respective ends of the actuator 113 in the longitudinal direction, for example. The third common liquid chambers 1163 allow the first common liquid chamber 1161 to communicate with the two second common liquid chambers 1162 at both ends of the pair of actuators 113 in the longitudinal direction. The third common liquid chambers 1163 form a flow path for a part of the ink from the first common liquid chamber 1161 to the second common liquid chambers 1162 without passing through the plurality of pressure chambers 1131 of each actuator 113. The third common liquid chambers 1163 form an ink flow path from the first common liquid chamber 1161 and the two second common liquid chambers 1162 to the discharge ports 1112.

As illustrated in FIGS. 1 to 8, the manifold unit 12 includes a manifold 121, a top plate 122, an ink supply pipe 123, an ink discharge pipe 124, a first temperature control water supply pipe 125, a first temperature control water discharge pipe 126, a damper 127, and a bypass flow path 128. The manifold unit 12 constitutes a flow path member that constitutes a flow path for the ink, and a first temperature adjustment flow path forming member that constitutes a flow path for the temperature control water that controls the temperature of the actuators 113. It should be noted that the numbers of the ink supply pipe 123, the ink discharge pipe 124, the first temperature control water supply pipe 125, and the first temperature control water discharge pipe 126 can be set as appropriate.

The manifold 121 is formed in a plate shape or a block shape. As illustrated in FIGS. 6 to 8, the manifold 121 includes supply paths 1211 that are continuous with the supply port 1111 of the base plate 111 and form liquid supply flow paths, discharge paths 1212 that are continuous with the discharge ports 1112 of the base plate 111 and form liquid discharge paths, and a first temperature adjustment flow path 1213 that forms a flow path for a temperature control fluid. It should be noted that the manifold 121 is connected to the pair of head bodies 11, and thus includes a pair of supply paths 1211 and a pair of discharge paths 1212.

One surface of the manifold 121 is fixed to the surface of the base plate 111. The top plate 122 is fixed to a surface of the manifold 121 opposite to the surface fixed to the base plate 111. The ink supply pipe 123, the ink discharge pipe 124, the first temperature control water supply pipe 125 and the first temperature control water discharge pipe 126 are fixed to the manifold 121 via the top plate 122, for example.

The manifold 121 includes, for example, the first manifold 1214 and a second manifold 1215. The manifold 121 is formed by assembling the first manifold 1214 and the second manifold 1215 together.

The supply path 1211 is a rectangular parallelepiped liquid chamber that is long in one direction (direction X) and is formed in the manifold 121 by holes or grooves. The supply path 1211 fluidly connects the ink supply pipe 123 to the supply port 1111 of the base plate 111.

For example, the supply path 1211 is a rectangular parallelepiped liquid chamber that extends along the longitudinal direction of the actuator 113 and the longitudinal direction of the supply port 1111. The supply path 1211 is a flow path for the liquid between the ink supply pipe 123 and the supply port 1111. The supply port 1111 is continuous with one side of the supply path 1211, and a damper 127 is provided on a ceiling 12111 on the other side of the supply path 1211.

The discharge path 1212 is a flow path formed in the manifold 121 by holes or grooves. The discharge path 1212 fluidly connects, for example, the ink discharge pipe 124 to the two discharge ports 1112 of the base plate 111.

The first temperature adjustment flow path 1213 is formed in the manifold 121 by holes or grooves. The first temperature adjustment flow path 1213 allows the temperature control water to flow, which controls (adjusts) the temperature of the actuator 113 and/or the temperature of the ink flowing through the actuator 113. The first temperature adjustment flow path 1213 fluidly connects the first temperature control water supply pipe 125 to the first temperature control water discharge pipe 126. The first temperature adjustment flow path 1213 adjusts a temperature of the head body 11 which is a liquid ejection portion. For example, the first temperature adjustment flow path 1213 adjusts the temperature of the actuator 113 to a predetermined temperature.

Both ends on a primary side and a secondary side of the first temperature adjustment flow path 1213 are openings connected to the first temperature control water supply pipe 125 and the first temperature control water discharge pipe 126 provided on one surface of the manifold 121. The first temperature adjustment flow path 1213 is formed so as to be capable of exchanging heat with the base plate 111 fixed to the manifold 121. The first temperature adjustment flow path 1213 adjusts the temperature of the actuator 113 through the base plate 111.

The first manifold 1214 is formed in a rectangular plate shape. The first manifold 1214 is formed with grooves and openings that constitute, for example, a part of the pair of supply paths 1211, a part of the pair of discharge paths 1212, and a part of the first temperature adjustment flow path 1213. Arrangement, sizes, and the like of the grooves and openings that form a part of the supply paths 1211 and the discharge paths 1212 are appropriately set based on the shapes of the supply paths 1211 and the discharge paths 1212 and the shapes of other fluid flow paths.

The second manifold 1215 is formed in a rectangular plate shape. The second manifold 1215 is formed with grooves and openings that constitute, for example, a part of the pair of supply paths 1211, a part of the pair of discharge paths 1212, and a part of the first temperature adjustment flow path 1213. Arrangement, sizes, and the like of the grooves and openings that form a part of the supply paths 1211 and the discharge paths 1212 are appropriately set based on the shapes of the supply paths 1211 and the discharge paths 1212 and the shapes of other fluid flow paths.

The first manifold 1214 and the second manifold 1215 are joined together to form the supply paths 1211, the discharge paths 1212, and the first temperature adjustment flow path 1213.

The top plate 122 is provided on a surface of the manifold 121 opposite to the surface on which the base plate 111 is provided. The top plate 122 has openings that allow the ink supply pipe 123, the ink discharge pipe 124, the first temperature control water supply pipe 125, and the first temperature control water discharge pipe 126 to communicate with the supply paths 1211, the discharge paths 1212, and the first temperature adjustment flow path 1213 of the manifold 121. For example, the top plate 122 is formed by two plate-like members. One of the ink supply pipe 123 and the ink discharge pipe 124, and one of the first temperature control water supply pipe 125 and the first temperature control water discharge pipe 126 are provided on one of the plate-like members. The other of the ink supply pipe 123 and the ink discharge pipe 124, and the other of the first temperature control water supply pipe 125 and the first temperature control water discharge pipe 126 are provided on the other of the plate-like members.

The ink supply pipe 123 is connected to the supply path 1211. The ink discharge pipe 124 is connected to the discharge path 1212. In the present embodiment, the liquid ejection head 1 includes the pair of head bodies 11, and therefore a pair of ink supply pipes 123 and a pair of ink discharge pipes 124 are provided. The first temperature control water supply pipe 125 and the first temperature control water discharge pipe 126 are pipes connected to the primary side and the secondary side of the first temperature adjustment flow path 1213.

In the present embodiment, the pair of ink supply pipes 123 and the first temperature control water discharge pipe 126 are arranged at one end side of the manifold 121 in a longitudinal direction thereof, and the pair of ink discharge pipes 124 and the first temperature control water supply pipe 125 are arranged at the other end side of the manifold 121 in the longitudinal direction.

As illustrated in FIGS. 6 to 8, the damper 127 is formed in an elastically deformable thin film or sheet shape. As illustrated in FIG. 7, the damper 127 covers the ceiling 12111 of the supply path 1211 formed by the second manifold 1215. The damper 127 elastically deforms in response to a pressure fluctuation in the supply path 1211. One surface of the damper 127 faces the supply path 1211.

As an example, the damper 127 is made of a polyimide film. The damper 127 is formed in a rectangular shape that is long in the same direction as a longitudinal direction (direction X) of an opening of the ceiling 12111 of the supply path 1211 that is long in one direction (direction X).

As illustrated in FIG. 6, the bypass flow path 128 connects the ceiling 12111 of the supply path 1211 to the common liquid chamber 116 or the secondary side of the common liquid chamber 116. It should be noted that the common liquid chamber 116 or the secondary side of the common liquid chamber 116 to which the bypass flow path 128 is connected is, for example, the second common liquid chamber 1162 or the third common liquid chamber 1163 of the common liquid chamber 116, the discharge path 1212 or the ink discharge pipe 124. The fluid resistance of the bypass flow path 128 is greater than the fluid resistance of the supply path 1211 and the fluid resistance of the common liquid chamber 116.

The bypass flow path 128 bypasses the supply path 1211 and the common liquid chamber 116, thereby discharging air bubbles within the supply path 1211 during maintenance or ink filling. The bypass flow path 128 is formed such that a cross-sectional shape of the flow path is rectangular or circular. The bypass flow path 128 is formed, for example, in a straight line or in a partially bent shape.

As illustrated in FIGS. 2, 4 and 10, the temperature adjustment flow path unit 13 includes, for example, a temperature adjustment flow path portion 131, a temperature control water top plate 132, a second temperature control water supply pipe 133, and a second temperature control water discharge pipe 134. The temperature adjustment flow path unit 13 is connected to a temperature control device of the liquid ejection device. The temperature adjustment flow path unit 13 cools the driving IC 142, which is a heating element, and constitutes the second temperature adjustment flow path forming member that prevents the temperature rise of the driving IC 142. The temperature adjustment flow path portion 131 is connected to the second temperature control water supply pipe 133 and the second temperature control water discharge pipe 134 via the temperature control water top plate 132. The temperature adjustment flow path portion 131 includes a branching flow path 1311 connected to the second temperature control water supply pipe 133, a second temperature adjustment flow path 1312 that cools a plurality of driving ICs, which will be described below, which are heating elements, and a merging flow path 1313.

The branching flow path 1311 is a flow path that branches the temperature control water supplied from the second temperature control water supply pipe 133 into two directions. One of the flow paths branched at the branching flow path 1311 is connected to the first temperature adjustment flow path 1213, and the other flow path branched at the branching flow path 1311 is connected to the second temperature adjustment flow path 1312. That is, the branching flow path 1311 branches the first temperature adjustment flow path 1213 and the second temperature adjustment flow path 1312 and supplies the temperature control water to the manifold unit 12 and the temperature adjustment flow path unit 13.

The second temperature adjustment flow path 1312 is connected to one of the flow paths branched at the branching flow path 1311. The second temperature adjustment flow path 1312 branches into a plurality of flow paths on the primary side, the number of which is less than the number of the plurality of driving ICs, and forms a flow path where the plurality of flow paths merge into one on the secondary side. The second temperature adjustment flow path 1312 allows the temperature control water to flow to cool the driving IC 142.

In the present embodiment, there are four nozzle rows 1142, four actuators 113 (four rows), and four driving ICs 142 (four rows). For this reason, as illustrated in FIGS. 2, 4 and 10, the temperature adjustment flow path portion 131 has three flow path portions 13121 that constitute the second temperature adjustment flow path 1312. The three flow path portions 13121 are long in one direction (direction X) and are arranged side by side in a direction (direction Y) perpendicular to the longitudinal direction of the flow path portions 13121.

The flow path portions 13121 are heat conducting portions that conduct heat from the driving IC 142. The three flow path portions 13121 include a pair of single-row temperature adjustment flow path portions 13122 and one plural-row temperature adjustment flow path portion 13123. The pair of single-row temperature adjustment flow path portions 13122 are arranged on both ends (outer sides) in an alignment direction (direction Y) of the three flow path portions 13121. Each of the pair of single-row temperature adjustment flow path portions 13122 cools the driving IC 142 that drives the actuator 113 that ejects the ink from the single-row nozzle row 1142. The corresponding driving IC 142 abuts against an outer surface of the single-row temperature adjustment flow path portion 13122.

The plural-row temperature adjustment flow path portion 13123 is disposed on an inner side in the alignment direction (direction Y) of the three flow path portions 13121. That is, the plural-row temperature adjustment flow path portion 13123 is disposed between the pair of single-row temperature adjustment flow path portions 13122 in the alignment direction of the three flow path portions 13121 (direction Y). The plural-row temperature adjustment flow path portion 13123 cools two driving ICs 142 that respectively drive two actuators 113 that eject the ink from two adjacent nozzle rows 1142 of the two sets of head bodies 11. Two corresponding driving ICs 142 abut against different outer surfaces of the plural-row temperature adjustment flow path portion 13123.

For example, as illustrated in FIGS. 4 and 10, a width WA of a flow path 131221 formed by the single-row temperature adjustment flow path portion 13122 is smaller than a width WB of a flow path 131231 formed by the plural-row temperature adjustment flow path portion 13123. The width WA of the flow path 131221 and the width WB of the flow path 131231 are widths in the direction Y in FIG. 10. A cross-sectional area of the flow path 131221 formed by the single-row temperature adjustment flow path portion 13122 is smaller than a cross-sectional area of the flow path 131231 formed by the plural-row temperature adjustment flow path portion 13123. A reason therefor is that the single-row temperature adjustment flow path portion 13122 cools one driving IC 142, whereas the plural-row temperature adjustment flow path portion 13123 cools two driving ICs 142. Therefore, in order to make a cooling ability of the plural-row temperature adjustment flow path portion 13123 higher than that of the single-row temperature adjustment flow path portion 13122, the width WB of the flow path 131231 of the plural-row temperature adjustment flow path portion 13123 is larger than the width WA of the flow path 131221 of the single-row temperature adjustment flow path portion 13122.

The merging flow path 1313 merges the first temperature adjustment flow path 1213 and the second temperature adjustment flow path 1312 and is connected to the second temperature control water discharge pipe 134. That is, the merging flow path 1313 merges the temperature control water flowing through the first temperature adjustment flow path 1213 and the second temperature adjustment flow path 1312 and discharges the temperature control water.

Such a temperature adjustment flow path portion 131 includes, for example, a temperature control manifold 1314, a cover 1315 that covers the temperature control manifold 1314, and a pair of temperature control blocks 1316 provided on the cover 1315.

The second temperature adjustment flow path 1312 is a flow path formed by holes and grooves formed in the temperature control manifold 1314, the cover 1315, and the pair of temperature control blocks 1316.

The temperature control manifold 1314 is formed in a plate shape or a block shape. The temperature control manifold 1314 is fixed to the manifold 121, for example. The temperature control manifold 1314 is formed with two openings 13141 in which a part of a wiring film 141 on which the driving IC 142, which will be described later, of the circuit board 14 is mounted and a printed wiring board 143 are disposed. The openings 13141 are aligned along a longitudinal direction (direction X) of the flow path portions 13121.

The temperature control manifold 1314 has three portions adjacent to the two openings 13141 that respectively form parts of the three flow path portions 13121. The temperature control manifold 1314 is formed with, for example, a groove 13142. The groove 13142 is shaped such that one flow path branches into three flow paths of the flow paths 131221 formed by the two single-row temperature adjustment flow path portions 13122 and the flow path 131231 formed by the plural-row temperature adjustment flow path portion 13123, and then the three flow paths are merged.

The cover 1315 is formed in a plate shape. The cover 1315 is formed with two openings 13151 along the longitudinal direction (direction X) of the flow path portions 13121, in which a part of the wiring film 141 and the printed wiring board 143 are disposed. The cover 1315 covers the groove 13142 formed on the temperature control manifold 1314 and is fixed to the temperature control manifold 1314 in a liquid-tight manner. The cover 1315 and the temperature control manifold 1314 constitute the second temperature adjustment flow path 1312. When the cover 1315 is assembled integrally with the temperature control manifold 1314, the two openings 13151 of the cover 1315 and the openings 13141 of the temperature control manifold 1314 face each other. The cover 1315 is formed with a plurality of openings that connect the second temperature adjustment flow path 1312 to the branching flow path 1311 and the merging flow path 1313, for example.

The temperature control blocks 1316 are formed with grooves and openings therein that form the branching flow path 1311 or the merging flow path 1313. Of the pair of temperature control blocks 1316, one temperature control block 1316 forms the branching flow path 1311, and the other temperature control block 1316 forms the merging flow path 1313. One temperature control block 1316 is a branching point forming portion that forms a branching point that branches the temperature control water, and the other temperature control block 1316 is a merging point forming portion that forms a merging point that merges the temperature control water. The pair of temperature control blocks 1316 are fixed to the cover 1315. The pair of temperature control blocks 1316 face each other in the direction X at a distance that allows the wiring film 141 of the circuit board 14 and the printed wiring board 143, which will be described later, to be disposed therebetween. The temperature control block 1316 has, for example, a pipe 13161 that connects the branching flow path 1311 or the merging flow path 1313 to the first temperature control water supply pipe 125 or the first temperature control water discharge pipe 126. The temperature control block 1316 is also formed with a plurality of ribs 13162 and a plurality of grooves 13163 for arranging and supporting the printed wiring boards 143, which will be described later, of the four circuit boards 14.

The temperature control water top plate 132 is provided on a surface of the pair of temperature control blocks 1316, which is opposite to the surface on which the cover 1315 is provided. For example, a pair of temperature control water top plates 132 are provided. Each temperature control water top plate 132 has an opening that connects the second temperature control water supply pipe 133 or the second temperature control water discharge pipe 134 to the branching flow path 1311 or the merging flow path 1313 of the temperature control block 1316. The temperature control water top plate 132 is formed with a plurality of grooves for arranging and supporting the printed wiring board 143, for example.

In the temperature adjustment flow path unit 13 configured in this manner, a heat conductivity of the flow path portion 13121, which is a heat conducting portion that conducts heat from the driving IC 142, is higher than a heat conductivity of the temperature control block 1316, which is a forming portion (branching point forming portion and merging point forming portion) that forms the branching point and the merging point of the temperature control water. That is, the temperature control manifold 1314 that forms the three flow path portions 13121 is made of a material that has a higher heat conductivity than the temperature control block 1316. For example, the temperature control manifold 1314 is made of a metal material, and the temperature control block 1316 is made of a resin material or the like that has a lower heat conductivity than the temperature control manifold 1314.

As an example, in the temperature adjustment flow path unit 13, the temperature control manifold 1314 is made of a metal material, and the cover 1315, the temperature control block 1316 and the temperature control water top plate 132 are made of a resin material with a lower heat conductivity than the temperature control manifold 1314.

The temperature adjustment flow path unit 13 is assembled integrally with the manifold unit 12 by connecting the pipe 13161 provided in the pair of temperature control blocks 1316 to the first temperature control water supply pipe 125 and the first temperature control water discharge pipe 126. Specifically, as illustrated in FIG. 11, the temperature adjustment flow path unit 13, which is the second temperature adjustment flow path forming member, comes into contact with the manifold unit 12, which is the first temperature adjustment flow path forming member, only at the pipe 13161 of the temperature control block 1316 serving as the branching point and the merging point of the first temperature adjustment flow path and the second temperature adjustment flow path, which are the branching point and the merging point. The manifold unit 12 does not come into contact with the temperature adjustment flow path unit 13 except for, for example, the pipe 13161 of the temperature control block 1316 which serves as a part of the branching point and the merging point of the temperature adjustment flow path unit 13.

As illustrated in FIGS. 1 to 4, one end of the circuit board 14 is connected to the wiring pattern of the actuator 113 via the wiring pattern of the base plate 111. The circuit board 14 includes, for example, the wiring film 141, the driving IC 142 mounted on the wiring film, and the printed wiring board 143 mounted on the wiring film.

The circuit board 14 drives the actuator 113 by applying a drive voltage to the actuator 113 via the wiring pattern of the base plate 111 using the driving IC 142, thereby increasing or decreasing the volume of the pressure chamber 1131 and ejecting droplets from the nozzle hole 1141.

The wiring film 141 is a film substrate formed in a so-called film shape and on which the wiring pattern is formed. For example, a plurality of wiring films 141 are provided. The wiring film 141 is, for example, a chip on film (COF) on which the driving IC 142 is mounted. For example, the number of wiring films 141 provided is the same as the number of the actuators 113 provided in one head body 11, that is, the same as the number of the nozzle rows 1142. Each wiring film 141 is connected to one actuator 113. It should be noted that the plurality of wiring films 141 may be connected to one actuator 113, in which case, the numbers of wiring film rows and driving IC rows including the plurality of wiring films 141 and the driving ICs 142 mounted on the wiring films 141 are the same as the number of the actuators 113.

In the present embodiment, two nozzle rows 1142 (two actuators 113) are provided in the head body 11, and therefore, one head body 11 is provided with two wiring films 141. The liquid ejection head 1 including two sets of head bodies 11 includes four wiring films 141. The four wiring films 141 are arranged, for example, in a manner of extending in the direction Z, and are arranged side by side in the direction Y in this posture.

The driving IC 142 is electrically connected to a wiring pattern formed in the pressure chamber 1131 via the wiring film 141. The driving IC 142 is a heating element that generates heat. The driving IC 142 is mounted on an outer surface of the wiring film 141. Here, the outer surface side of the wiring film 141 is a surface opposite to the surface (inner surface) on which the two wiring films 141 of one head body 11 face each other in an arranged posture of extending in the direction Z. In other words, the outside of the wiring film 141 means the outside of the head body 11 in the direction Y when the center side of the head body 11 in the direction Y is defined as the inside. Therefore, the outer surfaces of the two wiring films 141 on the inner side among the four wiring films 141 of the two sets of head bodies 11 face each other.

A surface of the driving IC 142 opposite to a mounting surface thereof mounted on the wiring film 141 abuts against an outer surface of the flow path portion 13121. For example, the surface of the driving IC 142 is in direct contact with the outer surface of the flow path portion 13121. One driving IC 142 is provided for each wiring film 141. It should be noted that a plurality of driving ICs 142 may be provided to drive one actuator 113, and the plurality of driving ICs 142 may be provided on one wiring film 141 to form a driving IC row. In this case, the plurality of driving ICs 142 in the same driving IC row abut against the corresponding flow path portion 13121.

One printed wiring board 143 is, for example, a printing wiring assembly (PWA) on which various electronic components and connectors are mounted.

The cover 15 covers or houses a part of the head body 11, a part of the manifold unit 12, and the circuit board 14.

The liquid ejection head 1 configured in this manner includes the first temperature adjustment flow path 1213 that performs temperature control on the actuator 113 of the head body 11 serving as the liquid ejection portion by the manifold unit 12 and the second temperature adjustment flow path 1312 that cools the driving IC 142 of the heating element by the temperature adjustment flow path unit 13. The temperature control water supplied from the second temperature control water supply pipe 133 passes through the first temperature adjustment flow path 1213 and the second temperature adjustment flow path 1312 and is discharged from the second temperature control water discharge pipe 134. The temperature control water flowing through the first temperature adjustment flow path 1213 performs temperature control on the actuators 113, and the temperature control water flowing through the second temperature adjustment flow path 1312 cools the driving ICs 142.

In the liquid ejection head 1, the second temperature adjustment flow path 1312 can cool the driving IC 142, which is a heating element, and therefore a damage to components around the driving IC 142 due to heat can be prevented. In the liquid ejection head 1, the first temperature adjustment flow path 1213 can adjust (control) the temperature of the actuator 113, and therefore a decrease in printing accuracy due to heat can be prevented.

The temperature adjustment flow path unit 13 is configured such that the heat conductivity of the temperature control manifold 1314 provided with the flow path portion 13121, which is a heat conducting portion that conducts the heat of the driving IC 142, is higher than the heat conductivity of the temperature control block 1316. In this way, the temperature adjustment flow path unit 13 can efficiently conduct heat between the driving IC 142 and the temperature control water via the flow path portion 13121. The temperature adjustment flow path unit 13 also can prevent the heat of the driving IC 142 conducted to the flow path portion 13121 from being conducted to the temperature control block 1316. Therefore, the temperature control block 1316 can be prevented from being heated by the heat of the driving IC 142, and the temperature of the temperature control water that is branched at the temperature control block 1316 and flows to the first temperature adjustment flow path 1213 can be prevented from rising due to the heat of the driving IC 142.

The manifold unit 12 that forms the first temperature adjustment flow path 1213 comes into contact with the temperature adjustment flow path unit 13 that forms the second temperature adjustment flow path 1312 only at the temperature control block 1316 that forms the branching point and the merging point of the first temperature adjustment flow path 1213 and the second temperature adjustment flow path 1312. Therefore, the heat from the driving IC 142 is conducted to the manifold unit 12 via the temperature control block 1316, which has low heat conductivity, and the heat from the driving IC 142 can be further prevented from being conducted to the manifold unit 12. The manifold unit 12 and the temperature adjustment flow path unit 13 are connected by the pipes 125, 126, and 13161. In this way, the cross-sectional area of the member (pipe) that conducts the heat between the manifold unit 12 and the temperature adjustment flow path unit 13 is made as small as possible, thereby further preventing heat from the driving IC 142 from being conducted to the manifold unit 12 (actuator 113).

As described above, according to the liquid ejection head 1, the heat conductivity of the temperature control block 1316 that forms the branching point and the merging point is made lower than the heat conductivity of the temperature control manifold (heat conducting portion) 1314. Therefore, in the liquid ejection head 1, the heat generated by the driving IC (heating element) 142 can be prevented from being conducted to the actuator 113, and temperature control on the actuator 113 and the driving IC 142 can be appropriately performed.

It should be noted that embodiments of the present disclosure are not limited to the above-described example. In the above example, the temperature control manifold 1314 is made of a metal material, and the cover 1315, the temperature control block 1316, and the temperature control water top plate 132 are made of a resin material with a lower heat conductivity than the temperature control manifold 1314. However, the present disclosure is not limited thereto. That is, the heat conductivity of the forming portion that forms the branching point and the merging point of the temperature control water may be lower than the heat conductivity of the heat conducting portion in contact with the driving IC 142. However, it is preferable that the member interposed between the temperature control manifold 1314 serving as a heat conducting portion and the temperature control block 1316 that forms the branching point and the merging point, and the member interposed between the temperature control block 1316 and the member of the manifold unit 12 that conducts heat to the actuator 113, have a lower heat conductivity than the heat conducting portion.

In the above example, the pipe 13161 provided in the pair of temperature control blocks 1316 is connected to the first temperature control water supply pipe 125 and the first temperature control water discharge pipe 126, which are pipes provided in the manifold unit 12, but the present disclosure is not limited thereto. For example, the temperature control block 1316 may not include the pipe 13161, and the first temperature control water supply pipe 125 and the first temperature control water discharge pipe 126, which are pipes for the temperature control water provided in the manifold unit 12, may be directly connected to the temperature control block 1316.

In the above example, the liquid ejection head 1 has four nozzle rows, but the present disclosure is not limited thereto. For example, the liquid ejection head 1 may have three sets of head bodies 11 and six nozzle rows. In the case of such a liquid ejection head 1, a pair of single-row temperature adjustment flow path portions 13122 may be provided at both end sides in the alignment direction (direction Y) of the nozzle rows, and two plural-row temperature adjustment flow path portions 13123 may be provided between the pair of single-row temperature adjustment flow path portions 13122.

In the above example, the surface of the driving IC 142 is in direct contact with the outer surface of the flow path portion 13121, but the present disclosure is not limited thereto. For example, the driving IC 142 may be in contact with the outer surface of the flow path portion 13121 via a member in a sheet shape, a tape shape, a gel form, a liquid form, or the like, made of a material with a high heat conductivity.

According to at least one of the embodiments described above, by making the heat conductivity of the branching point forming portion that branches the first temperature adjustment flow path and the second temperature adjustment flow path lower than the heat conductivity of the heat conducting portion that comes into contact with the heating element, the heat generated by the heating element can be prevented from being conducted to the actuator.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying embodiments and their equivalents are intended to cover such forms or modifications as would fall within the scope and spirit of the disclosure.

What is claimed is:

1. A liquid ejection head comprising:
a nozzle plate including a nozzle through which a first liquid is ejected;
a pressure chamber that communicates with the nozzle and stores the first liquid;
an actuator configured to change a volume of the pressure chamber to eject the first liquid;
a manifold unit that forms a first flow path running along the actuator and through which a temperature control liquid flows;
a driving IC configured to drive the actuator; and
a temperature adjustment structure that includes:
a temperature control manifold that forms a second flow path running along the driving IC and through which the temperature control liquid flows, and
a pair of temperature control blocks, one of the blocks forming a branching flow path through which the temperature control liquid flows into the first and second flow paths, and the other of the blocks forming a merging flow path by which the temperature control liquid from the first and second flow paths merges, wherein
a heat conductivity of the pair of temperature control blocks is lower than a heat conductivity of the temperature control manifold.

2. The liquid ejection head according to claim 1, wherein
the manifold unit and the temperature adjustment structure are in contact with each other at the pair of temperature control blocks.

3. The liquid ejection head according to claim 1, wherein
the temperature control manifold is made of a metal material, and
the pair of temperature control blocks are made of a resin material.

4. The liquid ejection head according to claim 1, further comprising:
a pipe that connects the manifold unit to the pair of temperature control blocks.

5. The liquid ejection head according to claim 1, wherein
the temperature adjustment structure further includes a cover that covers the temperature control manifold, and
the pair of temperature control blocks are provided on the cover.

6. The liquid ejection head according to claim 5, wherein
the cover is made of a resin material.

7. The liquid ejection head according to claim 1, further comprising:
a plurality of driving ICs configured to drive a plurality of actuators, wherein
the second flow path includes a first portion by which at least two of the plurality of driving ICs are cooled.

8. The liquid ejection head according to claim 7, wherein
the second flow path includes a second portion by which only one of the plurality of driving ICs is cooled.

9. The liquid ejection head according to claim 1, wherein
the driving IC extends in a longitudinal direction of the actuator, and
the second flow path includes a plurality of paths each extending in the longitudinal direction.

10. The liquid ejection head according to claim 9, wherein
a width of one of the plurality of paths is greater than a width of another one of the plurality of paths.

11. The liquid ejection head according to claim 9, wherein
a cross-sectional area of one of the plurality of paths is greater than a cross-sectional area of another one of the plurality of paths.

12. The liquid ejection head according to claim 1, wherein
the temperature control manifold includes a groove that forms the second flow path adjacent to the driving IC.

13. The liquid ejection head according to claim 1, wherein
the driving IC abuts against a surface of the temperature control manifold.

14. The liquid ejection head according to claim 1, further comprising:
a circuit board including the driving IC, wherein
the pair of temperature control blocks face each other and are spaced apart to allow for the circuit board to be disposed therebetween.

15. The liquid ejection head according to claim 1, wherein
the manifold unit includes a first manifold and a second manifold joined together to form the first flow path.
